(19) United States
(12) Patent Application Publication
(10) Pub. No.: US 2006/0260472 A1
(43) Pub. Date: Nov. 23, 2006

(54) Flip pan

(76) Inventor: Kenneth A. Tarlow, Corte Madera, CA (US)

Correspondence Address: Kenneth A. Tarlow, 21 GOLDEN HIND PSG, CORTE MADERA, CA, 94925, US

(21) Appl. No.: 11/131,472

(22) Filed: May 18, 2005

(51) Int. Cl. A47J 37/08

(52) U.S. Cl. 99/395

(57) ABSTRACT

Flip pan with a cooking pan including a metallic bottom plate and integral side walls, one or more U shaped flipping food holders and a hollow handle portion attached to the pan. The food holders lie side by side inside the pan and each include a centrally located non round shaft retaining aperture at one end and a fixed shaft at the opposite end. A cam device for each the food holder is located in the hollow handle portion and include a shaft having non tips that can engage with the food holders. The cam device also includes a pair of attached pull chains that terminate at a rotating chain pulling shaft. The chain pulling shaft includes a top knob portion that can be operated by the user so that when the user turns the knob, the food holders flip one hundred and eighty degrees.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of rangetop cooking pans and more specifically to a flip pan.

Range top cooking pans are well known. They generally consist of a metallic pan having a bottom panel and integral side walls, and often include an attached handle. They are designed to be used on stoves that have either gas or electric burners. Traditionally, when a person is cooking a fillet of fish, or meat or other item, he or she needs to periodically turn the item or items over so that they can be cooked evenly on both sides. This act is usually performed with a spatula or other cooking utensil that can grip or stab the item to be turned and then turn it.

Turning food with a spatula or other cooking tool can be problematic. Firstly, it the food items are spaced closely, it can be difficult to insert the spatula between them to retrieve one and turn it. Secondly, when returning the food item, it can be difficult to replace it in the exact spot that it occupied before turning. These two qualities usually lead to the food items being spaced some distance apart thereby wasting precious cooking space in the pan. Additionally, when frying foods, the cook can be exposed to very hot cooking oils that can spatter outside of the pan.

### BRIEF SUMMARY OF THE INVENTION

The primary object of the invention is to provide a range top cooking pan that allows the user to automatically flip items located within the pan without the need for an external spatula or other flipping tool.

Another object of the invention is to provide a cooking pan with a built in flipping means where that food holding flipping panels are removable and replaceable for easy cleaning.

Another object of the invention is to provide a cooking pan with built in flipping means where each food holding flipper is constructed with retaining ribs that match depressions in the pan bottom so that the majority of the food being cooked can have direct contact with the pan.

A further object of the invention is to provide a flip pan that is easy and economical to manufacture.

Yet another object of the invention is to provide a flip pan lid that includes anti-spatter screening to prevent hot frying oils from exiting the pan and where the lid does not have to be removed during the flipping process.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed flip pan comprising: a cooking pan including a metallic bottom plate and integral side walls, one or more U shaped flipping food holders and a hollow handle portion attached, said food holders capable of lying side by side inside said pan, said food holders being capable of removably retaining an item or items of food, said food holders each including a centrally located flat tipped shaft retaining portion at one end and a fixed shaft at the opposite end , a cam device for each said food holder, said cam device located in said hollow handle portion and including an integral, flat tipped shaft that can engage with said food holders, said cam device also including a pair of attached pull chains that terminate at a rotating chain pulling shaft, and said chain pulling shaft including a top knob portion that can be operated by the user so that when the user turns said knob in one direction said cams and said engaged food holders flip one hundred and eighty degrees and when turned in the opposite direction causes the food holder to flip in the opposite direction one hundred and eighty degrees.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention with the lid in place.

FIG. 3 is a top plan view of the invention with the handle top cover removed.

FIG. 4 is a perspective view of the food holding portion of the invention in the left hand resting position.

FIG. 5 is a perspective view of the food holding portion of the invention in the partly raised left hand position.

FIG. 6 is a perspective view of the food holding portion of the invention in the partly raised right hand position.

FIG. 7 is a perspective view of the food holding portion of the invention in the right hand resting position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

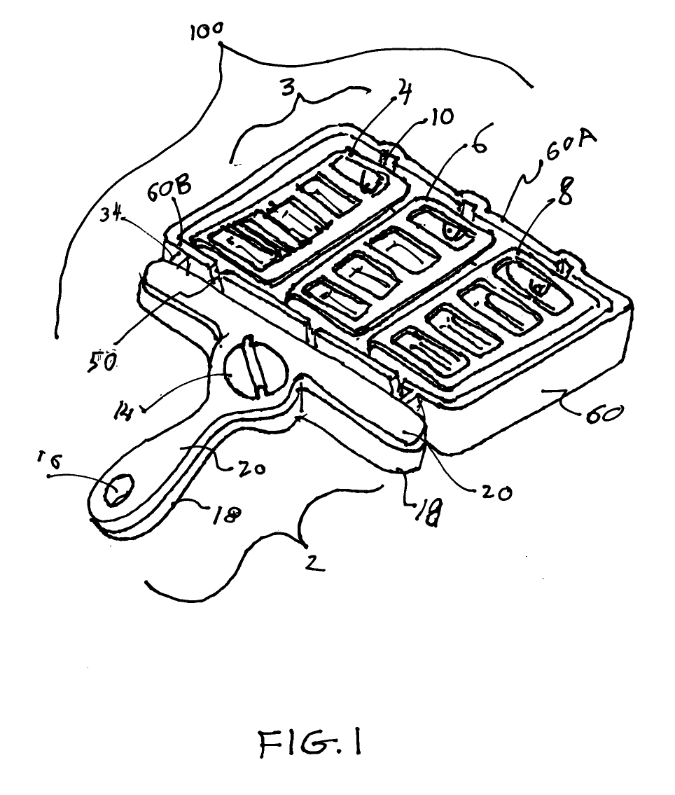

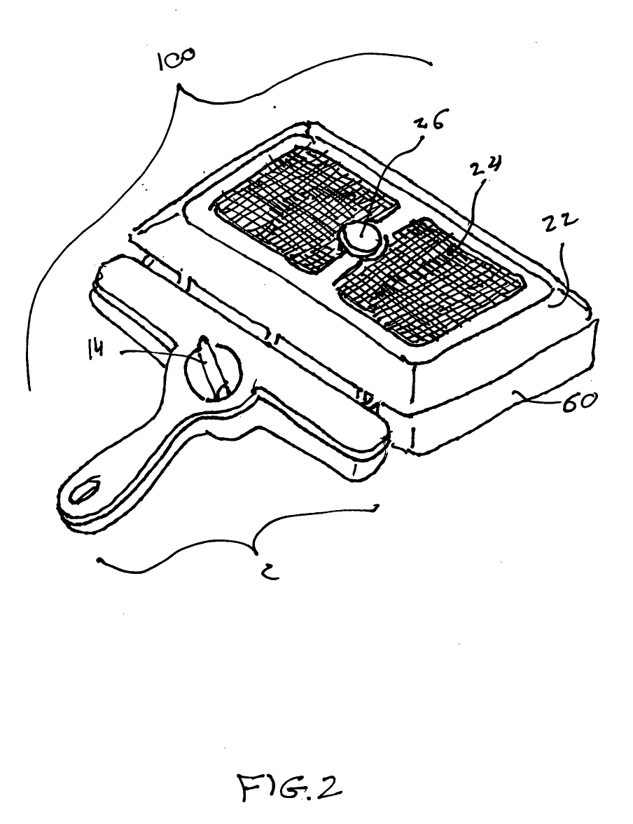

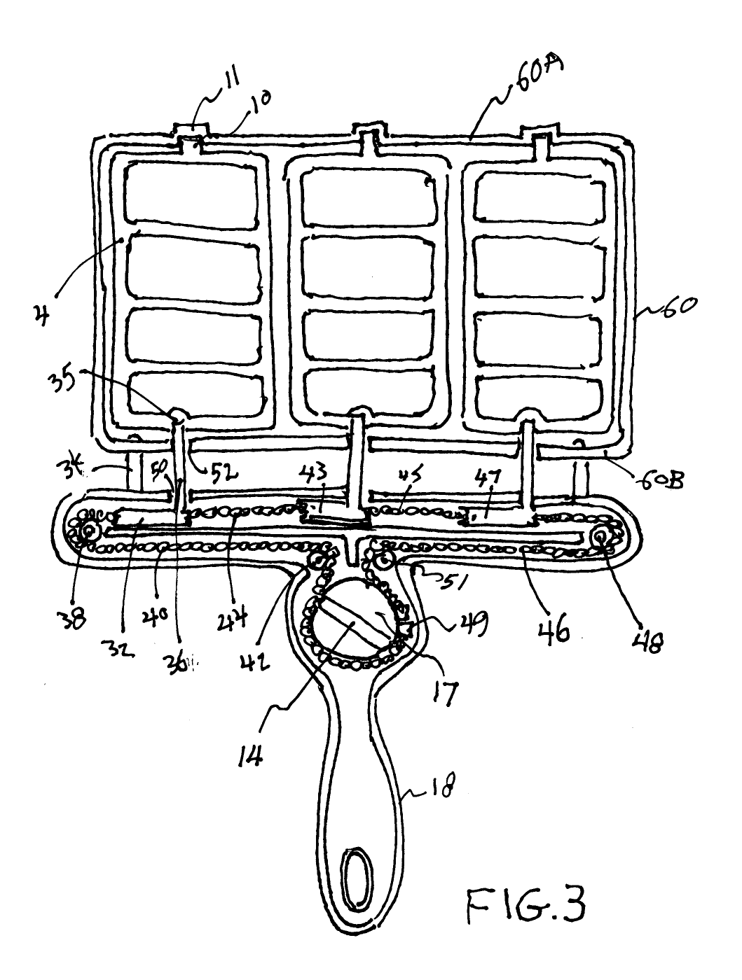

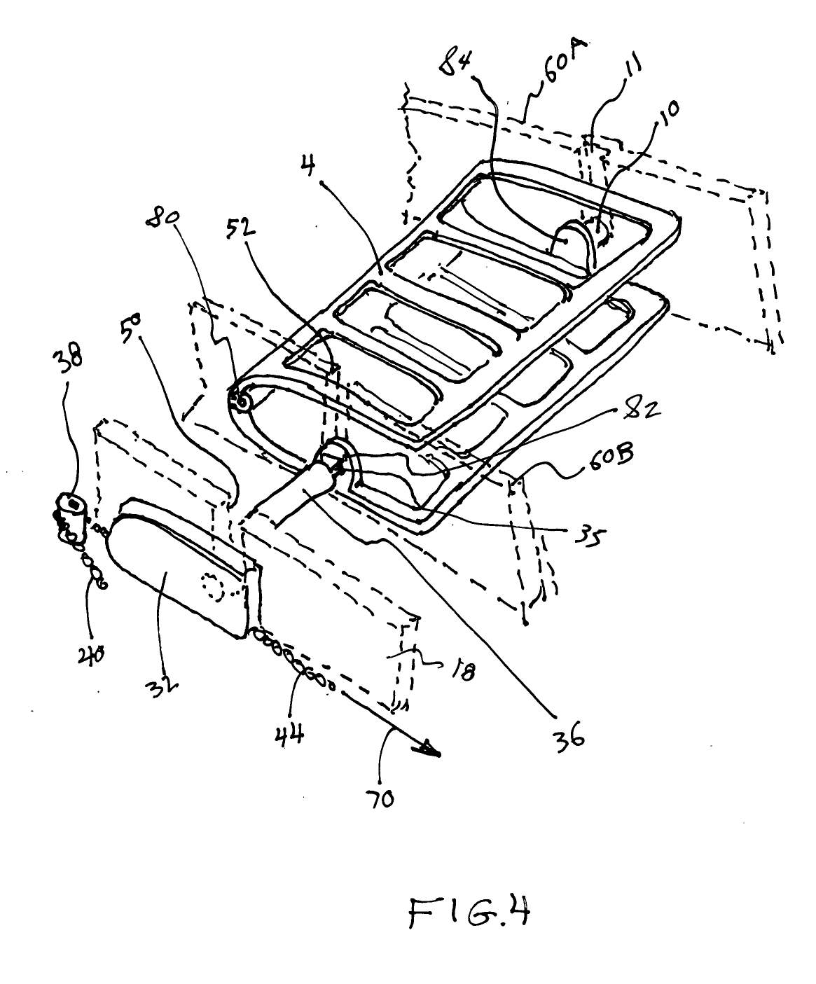

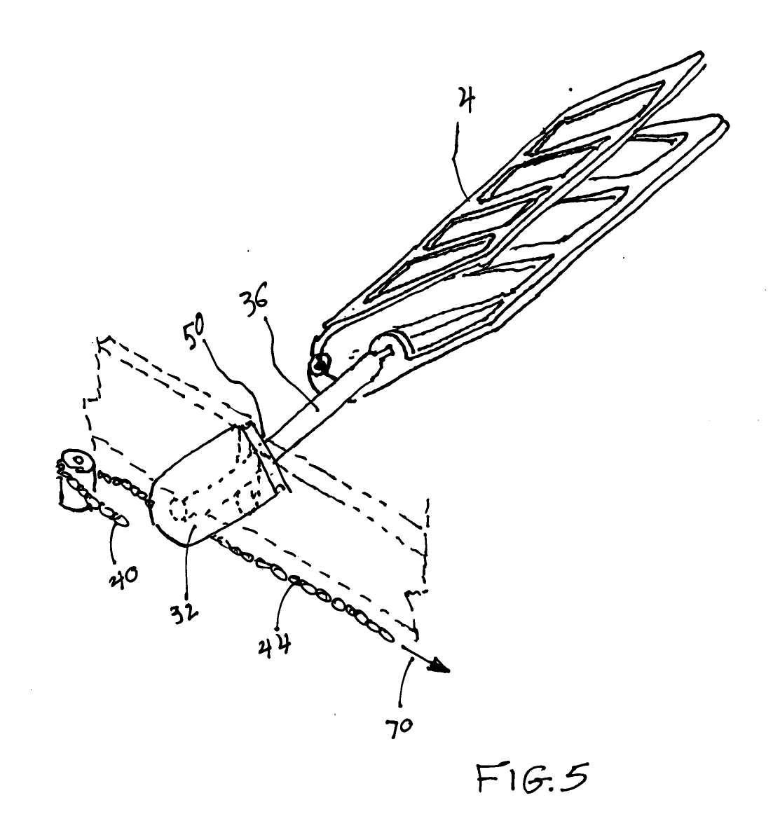

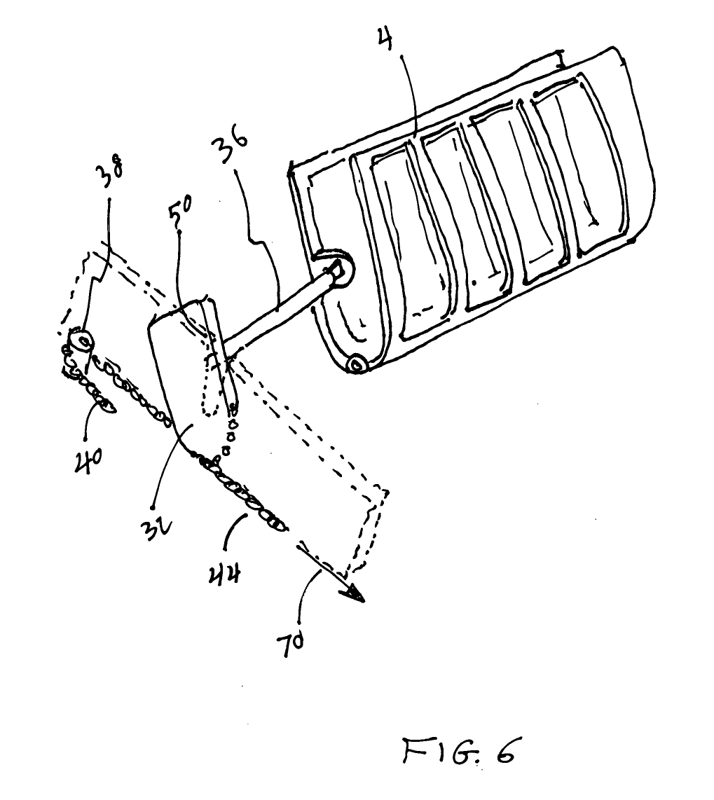

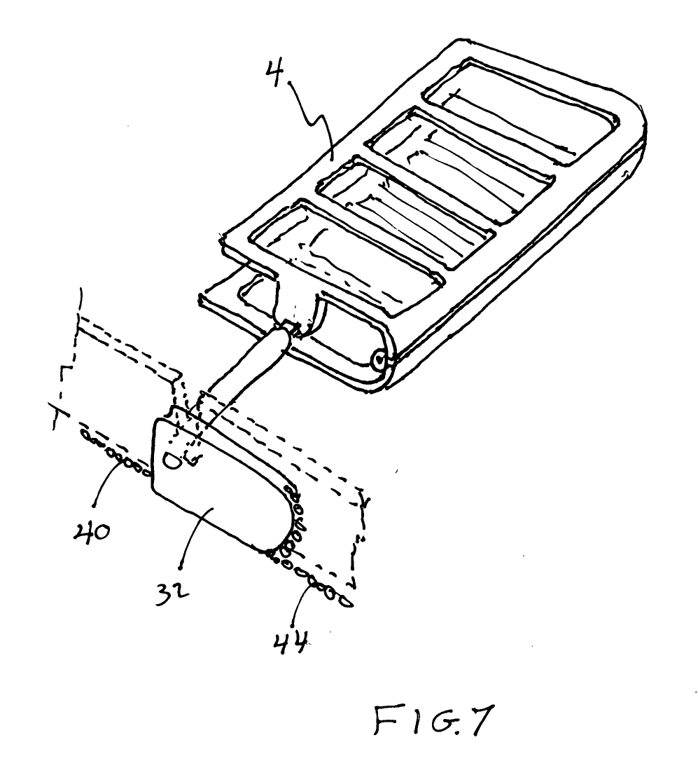

Referring now to FIG. 1 we see a perspective view of the invention 100. The invention 100 consists of a pan portion 3 and a handle portion 2. The pan portion consists of a cooking pan 60 made of metal such as steel or aluminum and included inside the pan are one or more identical food holders 4, 6, 8. The food holders include shafts that slidably engage with vertical slots 10 in far pan edge 60A and near pan edge vertical slots 60B. Handle portion 2 is hollow and comprised of a bottom portion 18 and a top cover 20. A turn knob 14 is built into the top cover 20 so that when a person turns the knob 14, food holders 4, 6, 8 flip one hundred and eighty degrees thereby allowing food contained within the holders to be cooked on both sides without the user having to turn each food item with a spatula. The pan portion 60 and the handle portion 2 are held at a distance from each other by ribs 34. The ribs 34 create a distance from the pan to the handle so that the handle portion is sufficiently removed from the heat of the stove top. Food holders 4, 6, 8 are U shaped as will be described below. The flat portions of the holders include large apertures leaving a plurality of ribs thereby allowing the food contained within the holders to be in direct contact with the pan bottom. Aperture 16 in pan handle 2 allows a person to hang the pan in the standard way. FIG. 2 shows the pan 100 with a lid 22 in place. The lid fits snuggly on the top of pan 60 in the standard way. the top includes apertures that are filled with fine steel screen mesh 24 so that a person can fry food such as fish of meat and not be spattered with hot oil. Because the lid is raised several inches from the top edge of the pan 60, food holders can be flipped by use of turning knob 14 without removing lid 22. In this way, the user will not be exposed to spattering hot oil during the process of cooking or flipping. Knob 26 is made of heat repelling material such as phenolic, so that the user can remove lid 22 without burning his or her fingers. FIG. 3 is a top plan view of the invention with the top cover of the handle removed. Handle bottom 18 is hollow so that knob 14 can be inserted as well as cams 32, 43, 47 and chains 44, 40, 45, 46. The cams and food holders are identical, so for description purposes I will describe only cam 32, food holder 4 and their actions. Cam 32 includes fixed shaft 36. Shaft 36 terminates in a non round portion such as a blade 35 that is inserted into a mating aperture in the end of food holder 4. A slot 52 in pan 60 as well as a slot 50 in handle portion 18 allows the shaft 36 to be able to slide up or down as needed. Bead chain 40 is connected at one end to cam 32 and at the opposite end to a tab 49 on the side of knob shaft 13. Roller bearings 38, 42 help guide chain 40 with minimum friction. Chain 44 is connected on one side to cam 32 and on the other side to cam 43. Likewise, chain 45 is connected between cam 43 and cam 47. Chain 46 extends out from the left of cam 47, around roller bearings 48, 51 to knob tab 49. FIG. 4 shows a partial perspective view of food holder 4 as well as cam 32 and shaft 36. The pan outer wall 60A and inner wall 60B as well as the front wall of handle portion 18 are shown by dotted lines. Blade portion 35 at the end of shaft 36 is clearly shown as it penetrates a mating aperture in a front tab 82. A rear tab 84 includes outwardly facing shaft 10 that is capable of sliding in slot 11. For purposes of the present explanation of operation, chain 44 is being pulled to the right as indicated by arrow 70. This action takes place when the user turns knob 14 and attached shaft 17 clockwise. FIGS. 5, 6 and 7 show the complete process of turning food holder 4 one hundred and eighty degrees so that the food contained within the food holder can be cooked on both sides. To accomplish this, cams, 32, 43 and 47 are caused to rotate because they are attached to each other by chains as described above. The rotation causes attached shaft 36 to cause food holder 4 to also rotate. This rotation causes shaft 36 to rise in slot 50 and then to fall again as the food holder is turned past ninety degrees. The excess chain is taken up on knob shaft 17 Hinge portion 80 allows the food holder 4 to be opened like a book to make it easier to add or remove food. The food holders 4, 6, 8 can also be easily removed from pan 60 and reinserted as needed. Turning the knob 14 to the left causes food holder 4 to rotate counter clockwise. In this way, the user can turn items being cooked automatically by turning knob 14 to the right or to the left. The process can be automated further by adding a standard motor drive or solenoid drive to knob portion 14 so that an attached timer can activate the food flipping function even while the user is not physically present. Obviously, the number of food holders can be varied from one to any practical plurality depending on the size of the cooking surface. An alternate embodiment is also possible where the bottom of the pan is removed and the entire unit is placed on an outdoor grill or the like. In this way, the same basic invention can be used while grilling foods that need to be flipped. Additionally, one versed in the art can conceive of other standard mechanical means to translate linear or rotary actuation into the food holder flipping action described above. For example, the use of pulleys, gears linkages or belts rather than the ball chain drive described above.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Flip pan comprising:
a cooking pan including a metallic bottom plate and integral side walls;
one or more U shaped metallic flipping food holders;
a hollow handle portion attached to said pan;
said food holders capable of lying side by side inside said pan;
said food holders being capable of removably retaining an item or items of food;
said food holders each including a centrally located non round shaft retaining portion at one end and a fixed shaft at the opposite end a cam device for each said food holder;
said cam device located in said hollow handle portion and including an integral, non round shaft tip that can engage with said food holders;
said cam device also including a pair of attached pull chains that terminate at a rotating chain pulling shaft; and
said chain pulling shaft including a top knob portion that can be operated by the user so that when the user turns said knob in one direction said cams and said engaged food holders flip one hundred and eighty degrees and when turned in the opposite direction causes the food holder to flip in the opposite direction one hundred and eighty degrees.

2. Flip pan as claimed in claim 1 wherein said pan includes vertical shaft retaining slots that allow said food holder shafts to slidably engage with said slots.

3. Flip pan as claimed in claim 1 further comprising a lid that fits snuggly on top of the top edge of said pan walls and allows the user to flip said food holders without removing said lid;
the top portion of said lid including a screened portion to allow air in but prevent hot oil spatter from exiting the inside of said pan.

4. Flip pan as claimed in claim 1 wherein said U shaped food holders are hinged along the spine to allow for easy placement of food within said holder.

5. Flip pan as claimed in claim 1 wherein said food holders include cut out portions that allow the majority of the food being held to be in direct contact with said pan bottom.

6. Flip pan as claimed in claim 1 wherein a standard motor or solenoid drive coupled with a standard timer device can cause said turning knob to operate automatically thereby allowing food to be flipped without the presence of an operator.

7. Flip pan as claimed in claim 1 wherein another standard mechanical system is used to cause rotational movement of said food holders, such as gears, pulleys or linkages or belts.
